(19) United States
(12) Patent Application Publication
(10) Pub. No.: US 2012/0012562 A1
(43) Pub. Date: Jan. 19, 2012

(54) METHOD FOR MACHINING WORKPIECE

(75) Inventors: CHI-HSIEN YEH, Tu-Cheng (TW); XIAO-JIANG JIANG, Shenzhen City (CN); CHIEN-HUNG KUO, Santa Clara, CA (US)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 12/980,298

(22) Filed: Dec. 28, 2010

(30) Foreign Application Priority Data
Jul. 19, 2010 (CN) 201010230873.3

(51) Int. Cl. B23K 11/00; B24C 1/00; B24B 1/00; B26D 1/00; B23C 1/00

(52) U.S. Cl. 219/117.1; 83/13; 409/131; 451/28; 451/38

(57) ABSTRACT

A method for machining at least one workpiece with multiple process includes providing a positioning assembly and at least two machining devices, positioning the at least one workpiece on the positioning assembly, positioning the positioning assembly on one of the at least two machining devices and machining the at least one workpiece, and transferring the positioning assembly together with the at least one workpiece on other different machining devices for undergoing different machining processes.

### BACKGROUND

1. Technical Field

The present disclosure relates generally to machining process, and more particularly, to a method for machining workpieces with multiple processes.

2. Description of Related Art

In machining workpieces, a machining device and a positioning assembly are often provided. The positioning assembly is generally fixed on the device to position the workpieces so that the device can accurately machine the workpieces. After the workpieces are machined, the workpieces are disassembled from the positioning assembly.

With the increasing market demands, workpieces require numerous operations to achieve an extensive range of predetermined sizes and configurations. Thus, the workpieces must be repeatedly assembled to and disassembled from different positioning assemblies of different devices. This transfer and mounting consumes time. Further, positional errors become increasingly likely, with definite impairment of machining precision. Further, damage to the workpieces is also more prevalent.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is a flowchart of an embodiment of a method of machining workpiece.

FIG. 2 is an isometric view of a first workpiece and a second workpiece before machining.

FIG. 3 is an isometric view of the first workpiece and the second workpiece positioned on a positioning assembly.

FIG. 4 is a cross-section of the first workpiece, the second workpiece, and the positioning assembly of FIG. 3, taken along line IV-IV.

FIG. 5 is an isometric view of the positioning assembly together with the first workpiece and the second workpiece of FIG. 2, positioned and milled on a milling machine.

FIG. 6 is an isometric view of the positioning assembly together with the first workpiece and the second workpiece of FIG. 2, positioned and ground on a grinding machine.

FIG. 7 is an isometric view of the positioning assembly together with the first workpiece and the second workpiece of FIG. 2, positioned and welded on a welding machine.

FIG. 8 is an isometric view of the positioning assembly together with the first workpiece and the second workpiece of FIG. 2, positioned and sandblasted on a sandblasting machine.

FIG. 9 is an isometric view of the positioning assembly together with the first workpiece and the second workpiece of FIG. 2, positioned and chamfered on a chamfering machine.

FIG. 10 is an isometric view of the positioning assembly together with the first workpiece and the second workpiece of FIG. 2, positioned and marked on a marking machine.

FIG. 11 is an isometric view of a final product.

### DETAILED DESCRIPTION

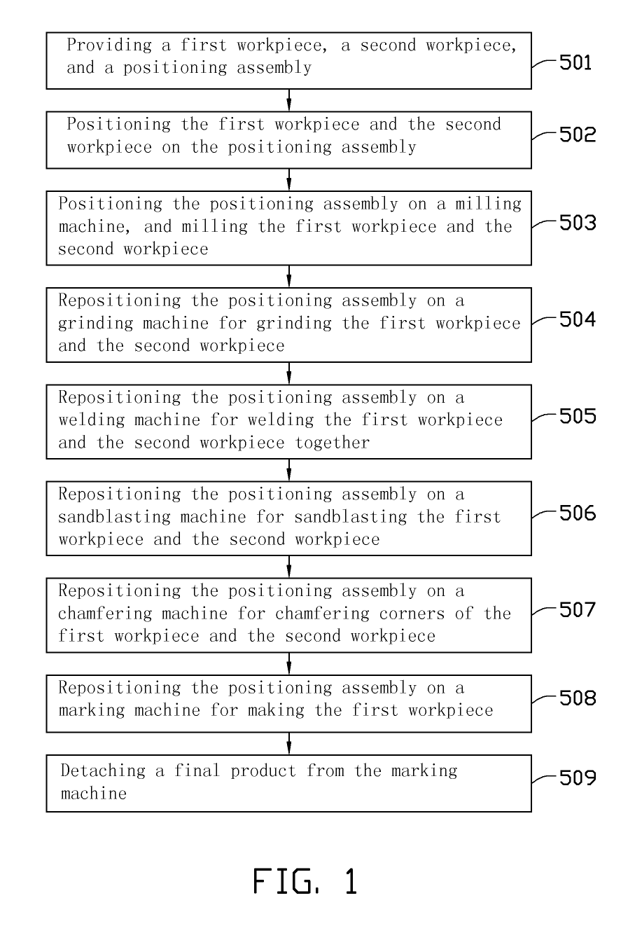

Referring to FIG. 1, an embodiment of a method of machining workpieces is as follows.

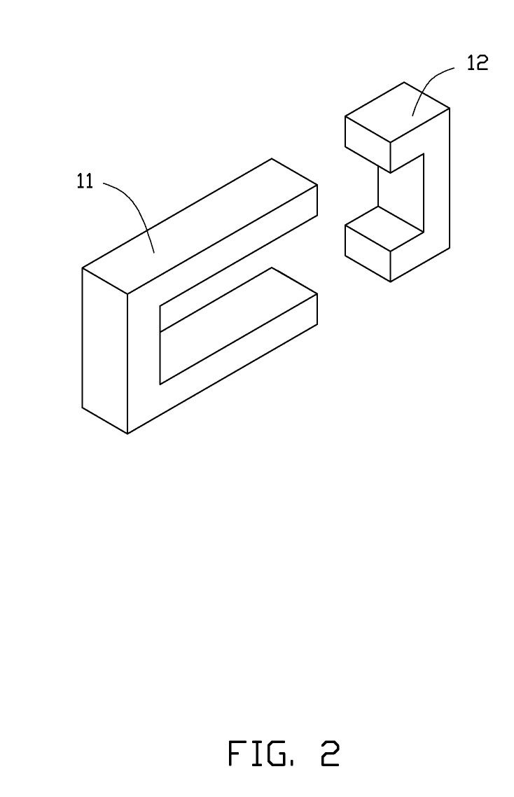

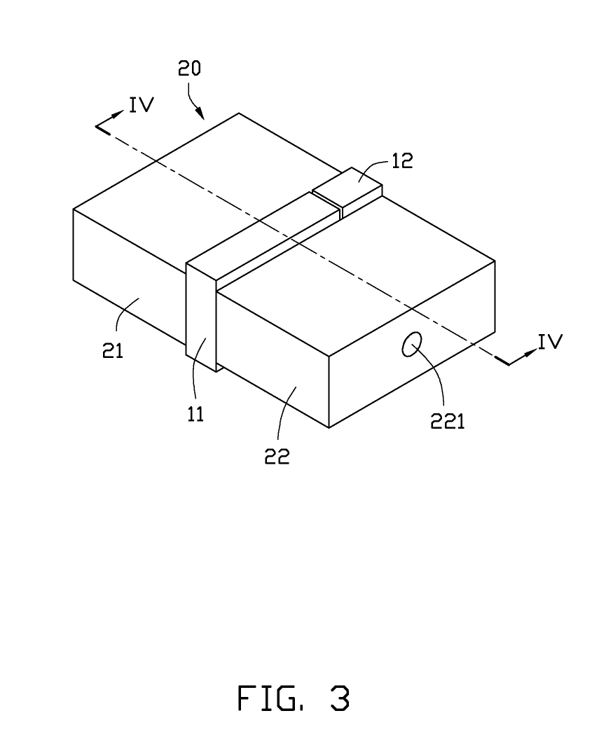

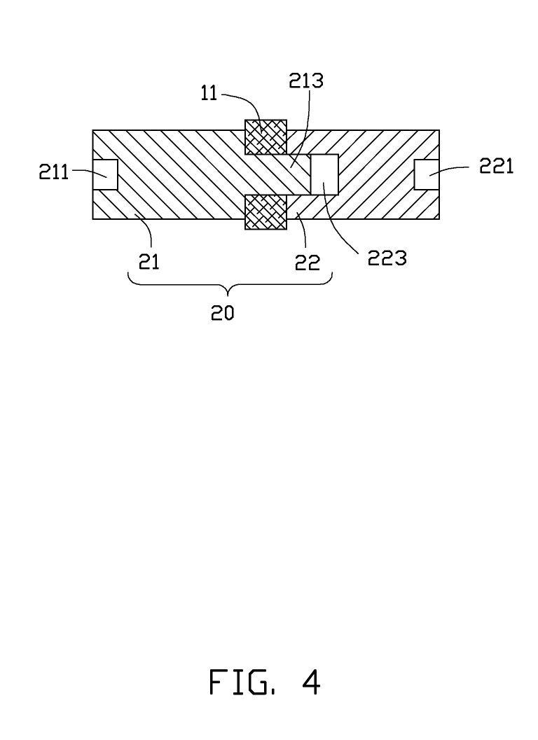

Referring to FIGS. 2 through 4, in a first step 501, a first workpiece 11, a second workpiece 12, and a positioning assembly 20 are provided. In the illustrated embodiment, the first workpiece 11 and the second workpiece 12 are substantially U-shaped, and a length of the first workpiece 11 exceeds that of the second workpiece 12. The first workpiece 11 and the second workpiece 12 are metal materials, such as stainless steel. The positioning assembly 20 includes a first clamping body 21 and a second clamping body 22. The first clamping body 21 forms a first positioning portion 211 and an assembly portion 213 (see FIG. 4). The first positioning portion 211 is defined in one end of the first clamping body 21 and the assembly portion 213 extends outward from an opposite end of the first clamping body 21. The second clamping body 22 forms a second positioning portion 221 in a first end of the second clamping body 22, and defines an assembly hole 223 in a second end opposite to the first end. The first positioning portion 211 and the second positioning portion 221 are grooves in this embodiment.

In a second step 502, the first workpiece 11 and the second workpiece 12 are positioned on the positioning assembly 20. In the illustrated embodiment, the first workpiece 11 and the second workpiece 12 are both sleeved on the assembly portion 213 of the first clamping body 21. The assembly portion 213 is then received in the assembly hole 223, until the first workpiece 11 and the second workpiece 12 are clamped by the first clamping body 21 and the second clamping body 22. The first workpiece 11 and the second workpiece 12 partially extend from an outer surface of the positioning assembly 20.

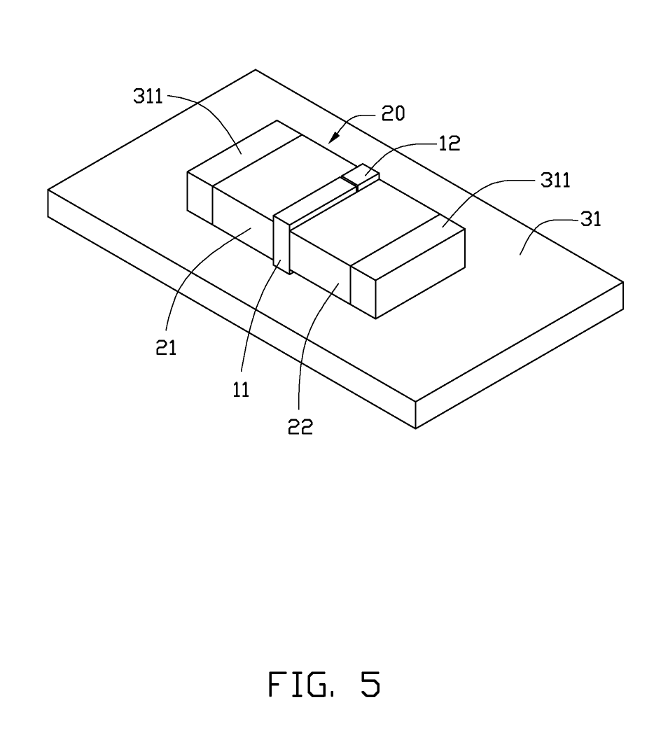

Referring to FIGS. 1 and 5, in a third step 503, a milling machine 31 is provided. The positioning assembly 20 is positioned on the milling machine 31 via the first positioning portion 211 and the second positioning portion 221. Outer surfaces of the first workpiece 11 and the second workpiece 12 are then milled by the milling machine 31. In the illustrated embodiment, the positioning assembly 20 is grasped by two fixing members 311 with protrusions (not shown) of the fixing members 311 received in the first positioning portion 211 and the second positioning portion 221 of the positioning assembly 20.

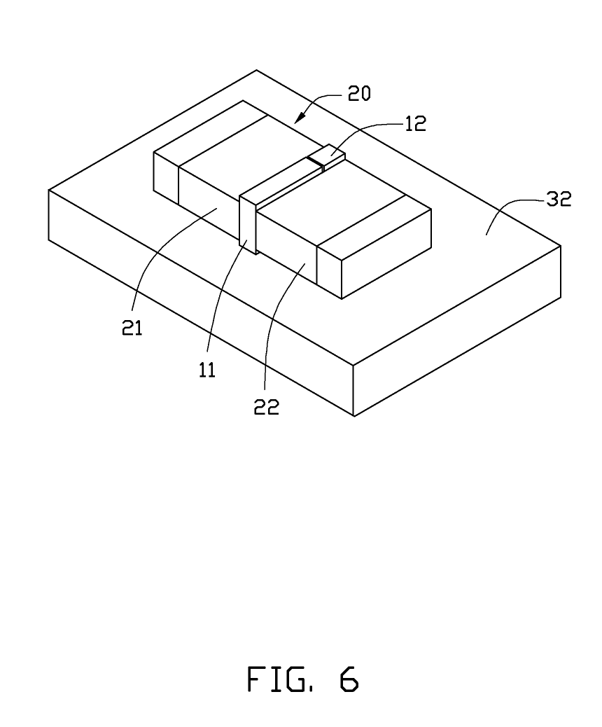

Referring to FIGS. 1 and 6, in a fourth step 504, the positioning assembly 20 is detached from the milling machine 31 and repositioned on a grinding machine 32 via the first positioning portion 211 and the second positioning portion 221. Outer surfaces of the first workpiece 11 and the second workpiece 12 are then grinded by the grinding machine 32.

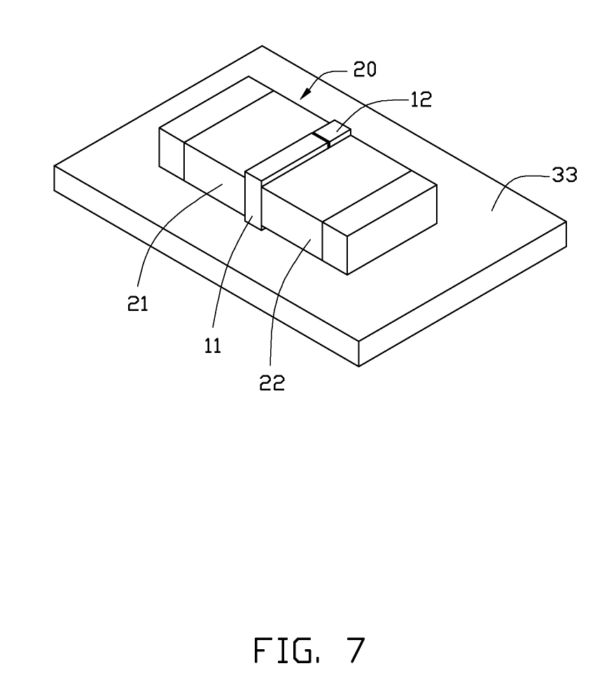

Referring to FIGS. 1 and 7, in a fifth step 505, the positioning assembly 20 is detached from the grinding machine 32 and repositioned on a welding machine 33 via the first positioning portion 211 and the second positioning portion 221. The first workpiece 11 and the second workpiece 12 are then welded by the welding machine 33. It should be appreciated that the first workpiece 11 and the second workpiece 12 can also be connected by an injection molding machine (not shown). In this case, the first workpiece 11 and the second workpiece 12 are connected by plastic material injected by the injection molding machine.

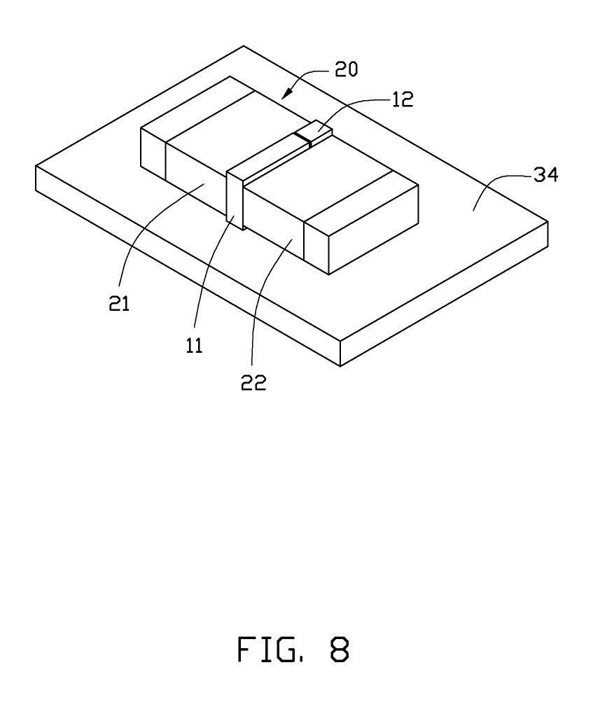

Referring to FIGS. 1 and 8, in a sixth step 506, the positioning assembly 20 is detached from the welding machine 33 and repositioned on a sandblasting machine 34 via the first positioning portion 211 and the second positioning portion 221. Outer surfaces of the first workpiece 11 and the second workpiece 12 are then sandblasted by the sandblasting machine 34.

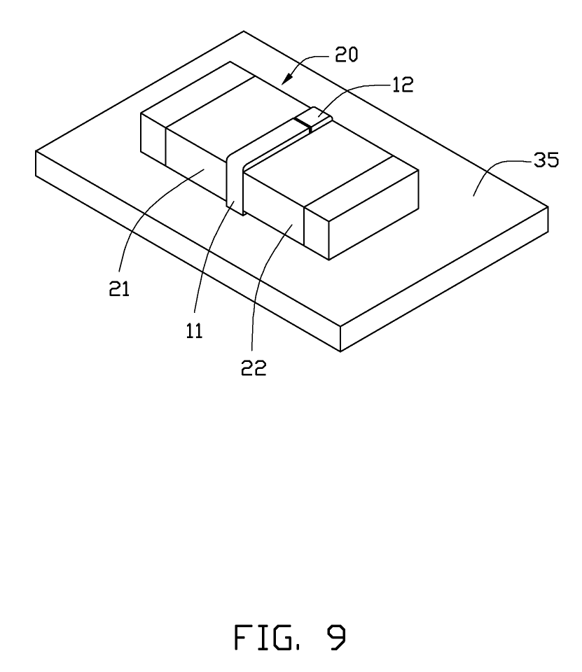

Referring to FIGS. 1 and 9, in a seventh step 507, the positioning assembly 20 is detached from the sandblasting machine 34 and repositioned on a chamfering machine 35 via the first positioning portion 211 and the second positioning portion 221. Corners of the first workpiece 11 and the second workpiece 12 are then chamfered by the chamfering machine 35.

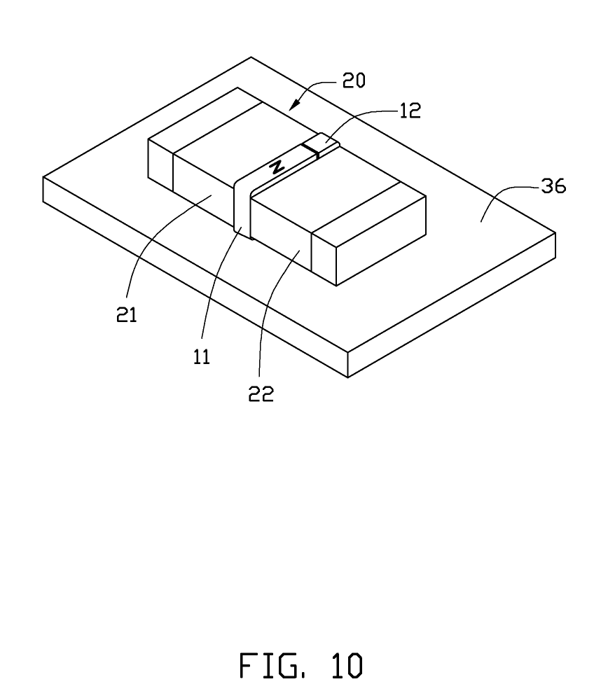

Referring to FIGS. 1 and 10, in an eighth step 508, the positioning assembly 20 is detached from the chamfering machine 35 and repositioned on a laser marking machine 36 via the first positioning portion 211 and the second positioning portion 221. A sign “N” is then marked on the first workpiece 11 by the laser marking machine 36 in this embodiment.

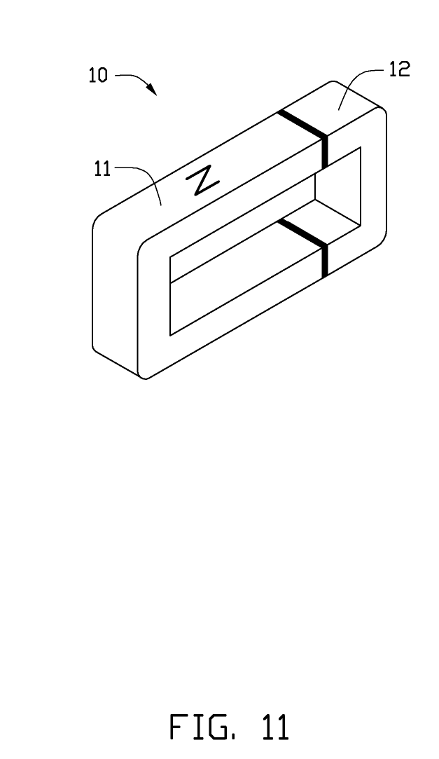

Referring to FIGS. 1 and 11, in a ninth step 509, after the machining processes described, a final product 10 is achieved and detached from the positioning assembly 20.

In machining, the first workpiece 11 and the second workpiece 12 are always combined with the positioning assembly 20 when transferred between different machining devices. Therefore, there is no need to detach or reposition the first workpiece 11 and the second workpiece 12 from or to different positioning assemblies of the different machining devices, thereby providing machining with high efficiency and precision. In addition, the first workpiece 11 and the second workpiece 12 avoid damage thereto. The positioning assembly 20 can be substantially rectangular, so that the positioning assemblies 20 are easy for stacking and handling.

It should be pointed out that, the above-described machining method of workpieces can also be applied for one workpiece or three or more workpieces. The positioning assembly 20 may also form more assembly portions 213 for assembling more workpieces, and one or more positioning portions 211, 221 for fixing onto the machining devices. The positioning portions 211, 221 may be positioning protrusions. In addition, a shape of the positioning assembly 20 can be designed according to shapes of workpieces.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A method for machining at least one workpiece with multi-processing, comprising:
providing a positioning assembly and at least two machining devices;
positioning the at least one workpiece on the positioning assembly;
positioning the positioning assembly together with the at least one workpiece on a first machining device of the at least two machining devices, and machining the at least one workpiece; and
transferring the positioning assembly together with the at least one workpiece on a second machining device of the at least two machining devices for experiencing different machining processes.

2. The method of claim 1, wherein the at least two machining devices comprises a milling machine, and the positioning assembly is positioned on the milling machine for milling the at least one workpiece.

3. The method of claim 2, wherein the at least two machining machines further comprises a grinding machine, and the positioning assembly is repositioned on the grinding machine for grinding the at least one workpiece.

4. The method of claim 3, wherein the at least two machining machines further comprises a welding machine, and the positioning assembly is repositioned on the welding machine for welding the at least one workpiece.

5. The method of claim 4, wherein the at least two machining machines further comprises a sandblasting machine, and the positioning assembly is repositioned on the sandblasting machine for sandblasting the at least one workpiece.

6. The method of claim 5, wherein the at least two machining machines further comprises a chamfering machine, and the positioning assembly is repositioned on the chamfering machine for chamfering corners of the at least one workpiece.

7. The method of claim 6, wherein the at least two machining machines further comprises a marking machine, and the positioning assembly is repositioned on the marking machine for marking a sign on the at least one workpiece.

8. The method of claim 1, wherein the at least one workpiece comprises a first workpiece and a second workpiece assembled on the positioning assembly.

9. The method of claim 8, wherein the first workpiece and the second workpiece are substantially U-shaped.

10. The method of claim 8, wherein the first workpiece and the second workpiece are welded together.

11. The method of claim 8, wherein the first workpiece and the second workpiece are connected together by plastic material.

12. The method of claim 1, wherein the positioning assembly forms an assembly portion for assembling the at least one workpiece thereon.

13. The method of claim 1, wherein the positioning assembly forms at least one positioning portion for positioning on the at least two machining devices.
